(19) United States
(12) Patent Application Publication
(10) Pub. No.: US 2010/0207940 A1
(43) Pub. Date: Aug. 19, 2010

(54) IMAGE DISPLAY METHOD AND IMAGE DISPLAY APPARATUS

(75) Inventor: Yasuhiro FURUTA, Shimosuwa-machi, Nagano (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/707,199

(22) Filed: Feb. 17, 2010

(30) Foreign Application Priority Data
Feb. 18, 2009 (JP) 2009-034749
Sep. 15, 2009 (JP) 2009-213774

(51) Int. Cl. G06T 15/00

(52) U.S. Cl. 345/419; 345/582; 345/600

(57) ABSTRACT

Provided is a method of displaying an image including: rendering a predetermined pattern of which each coordinate is set to a different grayscale value by pasting the pattern to a three-dimensional model as a texture, setting a corresponding relationship between a coordinate of a rendered image, which is obtained in a bitmap image form by the rendering, and a coordinate of the predetermined pattern for storing the rendered image as image drawing information by analyzing the rendered image, and arranging a desired texture in the rendered image for display based on the stored image drawing information when the desired texture is supposed to be displayed as an image.

### BACKGROUND

1. Technical Field

This application claims the benefit of Japanese Application No. 2009-034749, filed Feb. 18, 2009 and No. 2009-213774, Sep. 15, 2009 all of which are hereby incorporated by reference.

The present invention relates to an image display method of displaying an image and an image display apparatus.

2. Related Art

In the related art, a technique of rendering a three-dimensional model in real-time to display on a display (for example, JP-A-07-152925) or a technique of rendering a three-dimensional model in advance to create and store a bitmap image and then displaying the image on a display by reading the bitmap image was suggested as such kind of a image display method.

In the former technique, since there is a need to perform a rendering process in a shorter cycle than a screen-display cycle, high degree of operation capability is required. For that reason, insufficient operation capability may be available depending on the computer used, and thereby high quality image rendering such as a ray tracing cannot be performed. On the other hand, in the latter technique, since just the bitmap image is displayed, it is possible to display an image with high quality by subjecting it to rendering with high image quality and then creating the bitmap image in advance. However, at present, it is not possible to replace with a different texture in a later stage.

### SUMMARY

An advantage of some aspects of the invention is that it provides an image display method and an image display apparatus that have a low processing burden, and display a rendered image of a three-dimensional model with high quality.

The image display method and the image display apparatus of the invention employ the following components in order to achieve the aforementioned aspects.

According to an aspect of the invention, there is provided a method for displaying an image including rendering a predetermined pattern of which each coordinate is set to a different grayscale value by pasting the pattern to a three-dimensional model as a texture, setting a corresponding relationship between a coordinate of a rendered image, which is obtained in a bitmap image form by the rendering, and a coordinate of the predetermined pattern to store the rendered image as image drawing information by analyzing the rendered image, and arranging a desired texture in the rendered image for display based on the stored image drawing information when the desired texture is supposed to be displayed as an image.

In the method of displaying an image according to the aspect of the invention, a predetermined pattern of which each coordinate is set to a different grayscale value is pasted to a three-dimensional model as a texture and rendered, a corresponding relationship between a coordinate of a rendered image and a coordinate of the predetermined pattern are set and stored as image drawing information by analyzing the rendered image obtained in a bitmap image form by the rendering, and a desired texture in the rendered image is arranged and displayed based on the stored image drawing information when the desired texture is supposed to be displayed as an image. Accordingly, it is possible to display an image obtained by rendering the three-dimensional model by replacing with the desired texture, and to reduce the processing burden in comparison with a case of display by rendering a three-dimensional model in real-time. Here, the display of an image includes displaying an image as a dynamic image by drawing the image in a frame unit.

According to the aspect of the invention, there is provided the method in which the setting process is for deriving the corresponding relationship by specifying the coordinate of the predetermined pattern from a grayscale value of each coordinate of the rendered image corresponding thereto.

According to the aspect of the invention, there is provided the method in which the predetermined pattern is formed such that the grayscale value according to the value of a bit corresponding to each coordinate of the pattern is set to a plurality of patterns according to the number of bits when the coordinate is expressed by a binary number. With the configuration, the corresponding relationship can be set with more accuracy. In that case, the binary number is a gray code (an reflected binary code). With the configuration, a change always occurs by only 1 bit upon moving to an adjacent coordinate, and thereby, incorrect data resulting from an error in the grayscale value of an image can be prevented from being obtained.

According to the aspect of the invention, there is provided the method in which the rendering process renders a first solid color pattern solidly painted with a minimum grayscale value by pasting the pattern to the three-dimensional model in addition to a corresponding relationship setting pattern for setting the corresponding relationship as the predetermined pattern, the setting process stores a bias value, which is the grayscale value of the first solid color pattern in the rendered image, as the image drawing information, and the arranging process converts the grayscale value of the desired texture into the grayscale value of the rendered image for display by offsetting the grayscale value of the desired texture based on the stored bias value. With the configuration, it is possible to allow a resulting image to reflect an effect that does not depend on an original texture among effects resulting from rendering of a three-dimensional model.

According to the aspect of the invention, there is provided the method in which the rendering process respectively renders the first solid color pattern solidly painted with the minimum grayscale value and a second solid color pattern solidly painted with a maximum grayscale value by pasting the patterns to the three-dimensional model in addition to the corresponding relationship setting pattern for setting the corresponding relationship as the predetermined pattern, the setting process calculates a gain, which is a difference between the grayscale value of the first solid color pattern and the grayscale value of the second solid color pattern in the rendered image, to store the gain as the image drawing information, and the arranging process converts the grayscale value of the desired texture into the grayscale value of the rendered image based on the stored gain for display. With the configuration, it is possible to allow a resulting image to be influenced by the grayscale value of an original texture among effects resulting from rendering of a three-dimensional model. According to the method of the aspect, when a plurality of desired textures are arranged in the rendered image for display in the arranging process, the rendering process renders a first set group, which is a set group provided with as many as the desired textures to be arranged, each set of which includes one second solid color pattern and the first solid color patterns the number of which is obtained by subtracting a value 1 from the number of the textures to be arranged, and each of which has a different spot where the second solid color pattern is pasted to the three-dimensional model, and a second set including the same number of the first solid color patterns as that of the desired textures to be arranged by pasting the patterns to the three-dimensional model for each of the sets, and the setting process specifies a texture region where a texture is pasted to the three-dimensional model and calculates the gain for the specified texture region by comparing the grayscale value of each rendered image obtained by rendering the first set group for each of the sets to the grayscale value of the rendered image obtained by rendering the second set for each of the sets in the first set group. With the configuration, it is possible to specify a texture region more easily.

According to another aspect of the invention, there is provided an apparatus for displaying an image, including a storing unit that stores a corresponding relationship between a coordinate of a rendered image obtained in a bitmap image form by pasting a predetermined pattern, of which each coordinate is set to a different grayscale value, to a three-dimensional model as a texture and rendering, and a coordinate of the predetermined pattern, and a displaying unit that arranges a desired texture in the rendered image for display based on the corresponding relationship stored in the storing unit when the desired texture is supposed to be displayed as an image.

With the apparatus for displaying an image according to the aspect, it is possible to store a corresponding relationship between a coordinate of a rendered image obtained in a bitmap image form by pasting a predetermined pattern, of which each coordinate is set to a different grayscale value, to a three-dimensional model as a texture and rendering, and a coordinate of the predetermined pattern, and thereby to arrange a desired texture in the rendered image for display based on the stored image drawing information in the storing unit when the desired texture is supposed to be displayed as an image. Accordingly, it is possible to display an image obtained by rendering the three-dimensional model by replacing with the desired texture, and to reduce the processing burden in comparison with a case of display by rendering a three-dimensional model in real-time.

### BRIEF DESCRIPTION OF THE DRAWINGS

The invention will be described with reference to the accompanying drawings, wherein like numbers reference like elements.

FIG. 1 is a schematic diagram illustrating a configuration of a computer used in the image display method.

FIG. 2 is a flowchart illustrating an example of a special texture generation process.

FIG. 3 is a group of diagrams illustrating an example of special textures.

FIG. 4 is a group of diagrams illustrating the appearance of rendering special textures for each set.

FIG. 5 is a flowchart illustrating an example of a rendered image analysis process.

FIG. 6 is a graph showing a bias B_{c,t}(x,y) and a gain G_{c,t}(x,y).

FIG. 7 is a group of diagrams illustrating an example of textures for replacement.

FIG. 8 is a diagram illustrating an example of slide show display of textures for replacement.

FIG. 9 is a group of diagrams illustrating special textures of a modified example.

FIG. 10 is a group of diagrams illustrating the appearance of rendering by using the special textures in the modified example.

FIG. 11 is a group of diagrams illustrating the special textures in the modified example.

### DESCRIPTION OF EXEMPLARY EMBODIMENTS

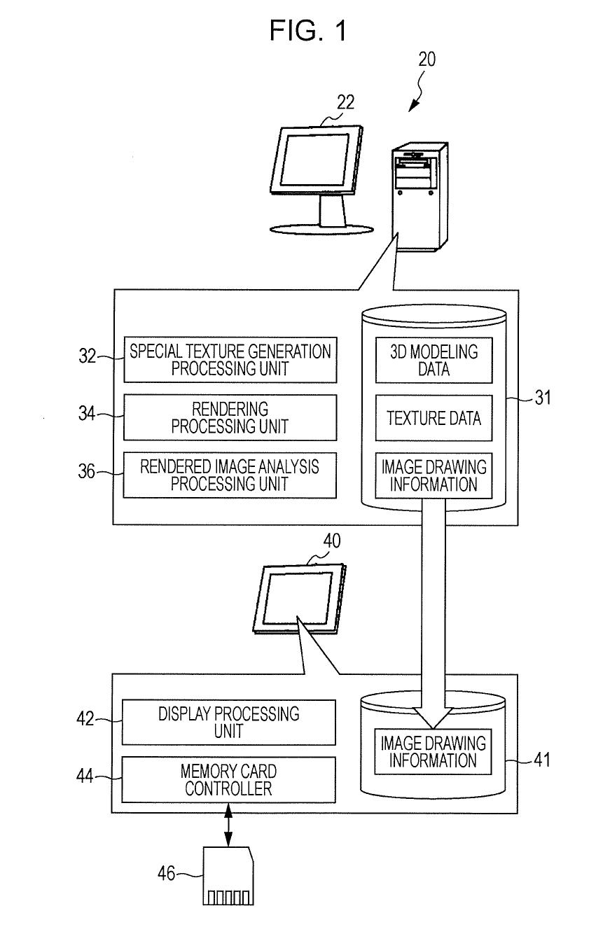

Hereinafter, an exemplary embodiment of the invention will be described with reference to accompanying drawings. FIG. 1 is a diagram illustrating a configuration of a computer 20 and a viewer 40 used in the image display method as an embodiment of the invention. The computer 20 according to the embodiment is a general computer including a CPU as a central arithmetic processing device, a ROM storing processing programs, a RAM temporarily storing data, a graphic processor (GPU), a hard disc drive (HDD), a display 22, and the like. As functioning blocks, the computer 20 includes a storing unit 31 for storing three-dimensional modeling data (hereinafter, referred to as a 3D model), texture data pasted thereto (hereinafter, referred to as a texture), and the like, a special texture generation processing unit 32 for generating a special texture to be pasted to a three-dimensional model for pre-processing, a rendering processing unit 34 for rendering the three-dimensional model to generate a bitmap image, and a rendered image analysis processing unit 36 for analyzing the rendered image obtained by the rendering as the bitmap image.

The special texture generation processing unit 32 is a processing unit for generating a texture of a predetermined pattern to be pasted to a 3D model to be subjected to rendering in the rendering processing unit 34. Specifically, as the predetermined pattern, the special texture generation processing unit 32 generates a solid white pattern with 1.0 grayscale value within the range of 0.0 to 1.0 grayscale value, a solid black pattern with 0.0 grayscale value, a vertically-striped pattern where 0.0 and 1.0 grayscales are shown alternately in the horizontal direction, and a horizontally-striped pattern where 0.0 and 1.0 grayscales are shown alternately in the vertical direction. Roles of each of the patterns will be described later.

The rendering processing unit 34 is a processing unit functioning by installing a software for 3D rendering in the computer 20, and reproduce a bitmap image in a frame unit by a predetermined frame rate (for example, 30 or 60 times per second) to display as a dynamic image, by pasting a texture generated in the special texture generation processing unit 32 to a 3D model and rendering the texture. In the present embodiment, the rendering process is performed by using the ray tracing method in which reflection on an object surface or refraction of light is calculated while following the light from a light source and rendering is performed.

The rendered image analysis processing unit 36 analyzes a bitmap image (rendered image) generated by the rendering processing unit 34 and generates image drawing information so as to arrange desired image data such as a picture instead of a texture having a predetermined pattern and display the rendered image on the viewer 40.

The viewer 40 in the present embodiment includes a storing unit 41 for storing the image drawing information as a result analyzed in the rendered image analysis processing unit 36 of the computer 20, a display processing unit 42 for displaying the rendered image by arranging and drawing the desired texture in the rendered image of the 3D model, and a memory card controller 44 undertaking exchange of data with a memory card 46 storing image data such as a picture. The viewer 40 sequentially reads a plurality of image data stored in the memory card 46 by an instruction from a user and performs slide show display for which the read image data are pasted to the rendered image of the 3D model by using the image drawing information and sequentially reproduce the image.

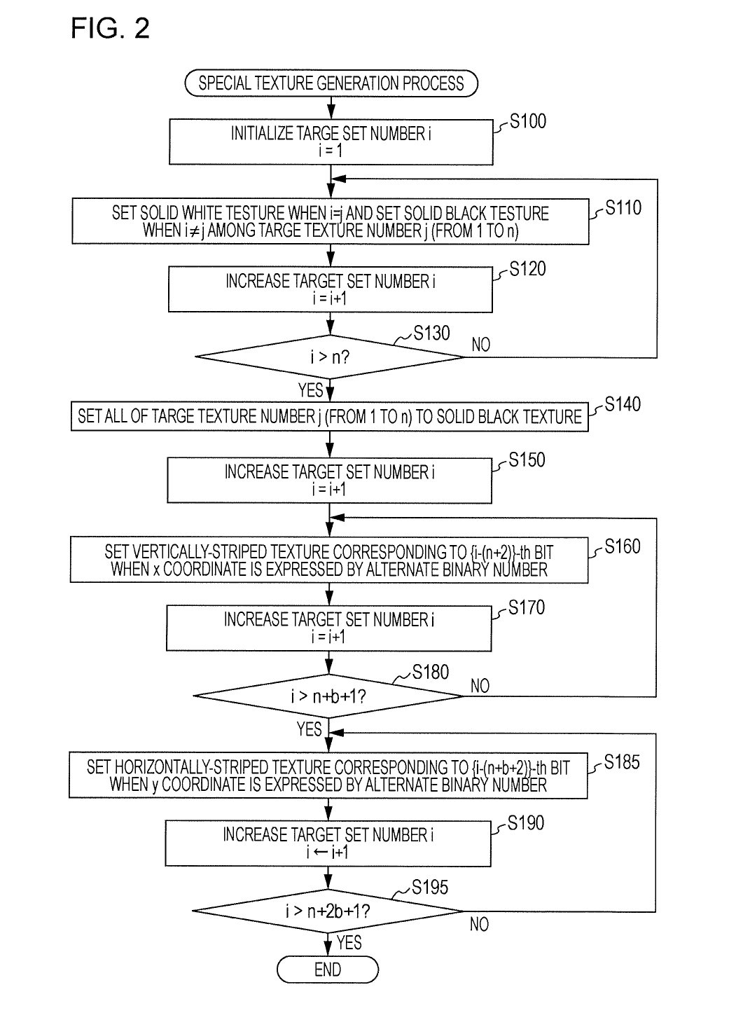

Next, the operation of the special texture generation processing unit 32 and the rendered image analysis processing unit 36 of the computer 20 and the operation of the display processing unit 42 of the viewer 40 configured as above according to the present embodiment will be described. First, the process of the special texture generation processing unit 32 will be described. FIG. 2 is a flowchart illustrating an example of the special texture generation process.

In the special texture generation process, first, a target set number i is initialized to a value 1 (step S100), n number of special textures are generated for each color component of RGB for the target set number i (step S110), the target set number i is increased by the value 1 (step S120), the target set number i is compared to a value n (step S130). The process returns to the step S110 when the target set number i is equal to or smaller than the value n, and a process for generating n number of special textures for the next target set number i is repeated, and the process advances to the next when the target set number i exceeds the value n. Here, the generation of the special texture from the value 1 to the value n of the target set number i is performed by comparing a target texture number j to the target set number i while replacing with the first to n-th target texture number j by the value 1 from the first, generating a solid white special texture by setting the value 1.0 of grayscale in all coordinates (x,y) within the grayscale value range from the minimum value 0.0 (black) to the maximum value 1.0 (white) for the target texture number j that matches with the target set number i, and generating a solid black special texture by setting the value 0.0 of grayscale in the all coordinates (x,y) for the target texture number j that does not match with the target set number i, as shown in the following equation (1). Here, ‘c’ in the equation (1) represents a value corresponding to each color of RGB value of image data, ‘n’ represents the number of textures arranged in one screen, ‘b’ represents the number of bits when a coordinate of a texture is expressed by a binary number, and ‘T_{c,i,j}(x,y)’ represents a grayscale value of the coordinate (x,y) of the special texture in a color component c, a target set number i, and a target texture number j (hereinafter, the same is applied).

Expression 1

When i=j, T_{c,i,j}(x,y):=1.0

When i≠j, T_{c,i,j}(x,y):=0.0 (1)

c:=1˜3, i:=1˜n, j:=1˜n, x:=1˜2^{b}, y:=1˜2^{b}

After special textures having the target set number i from a value 1 to a value n are generated, n number of special textures having the target set number i of a value (n+1) are generated for each color component (step S140), and the target set number i is increased by a value 1 (step S150). Here, the generation of the special textures having the target set number i of the value (n+1) is performed by generating the solid black special texture by setting a value 0.0 of grayscale in the all coordinates (x, y) for all of the first to n-th target texture number j, as shown in the following equation (2).

Expression 2

T_{c,n+1,j}(x,y):=0.0 (2)

c:=1˜3, j:=1˜n, x:=1˜2^{b}, y:=1˜2^{b}

After special textures having the target set number i of the value (n+1) are generated, n number of vertically-striped special textures are generated by the next equation (3) for each color component, corresponding to {i−(n+2)}-th bit when a coordinate of a texture is expressed by an reflected binary code (gray code) for the target set number i (step S160), the target set number i is increased by a value 1 (step S170), and the target set number i is compared to a value (n+b+1) (step S180). The process returns to step S160 when the target set number i is equal to or smaller than the value (n+b+1), a process of generating n number of special textures for the next target set number i is repeated, and the process advances to the next when the target set number i exceeds the value (n+b+1). Here, ‘gray(a)’ in the equation (3) represents the expression of a gray code of a value a (reflected binary code sign), and ‘and(a,b)’ represents an AND operation for each bit of a and b (hereinafter, the same is applied). (n+2)-th to (n+b+1)-th target set number i correspond to each bit from 0-th bit (the highest bit) to (b−1)-th bit (the lowest bit) when each coordinate of textures are expressed by a binary number, and vertically-striped special textures are generated by setting the grayscale of the value 1.0 (white) when a value of a bit corresponding to the target set number i is the value 1, and by setting the grayscale of the value 0.0 (black) when a corresponding value of a bit is the value 0. In the present embodiment, the coordinate of textures are expressed by an reflected binary code, for example, when n, the number of textures is a value 3 and the coordinate is 3 bit of a value 1 to 8 (b=3), and if a special texture has a value 5 representing the target set number i of 0-th bit (the highest bit), a black grayscale value is set for the x coordinate of values 1 to 4 and a white grayscale value is set for the x coordinate of values 5 to 8. If a special texture has a value 6 representing the target set number i of the first bit, a black grayscale value is set for the x coordinate of values 1 and 2, a white grayscale value is set for values 3 to 6, and a black grayscale value is set for values 7 and 8. If a special texture has a value 7 representing the target set number i of the second bit (the lowest bit), a black grayscale value is set for the x coordinate of a value 1, a white grayscale value is set for values 2 and 3, a black grayscale value is set for values 4 and 5, a white grayscale value is set for values 6 and 7, and a black grayscale value is set for a value 8.

Expression 3

When and(gray(x−1),2ⁱ⁻⁽ⁿ⁺²⁾≠0, T_{c,i,j}(x,y):=1.0

When and(gray(x−1),2ⁱ⁻⁽ⁿ⁺²⁾=0, T_{c,i,j}(x,y):=0.0 (3)

c:=1˜3, i:=n+2˜n+b+1, j:=1˜n, x:=1˜2^{b}, y:=1˜2^{b}

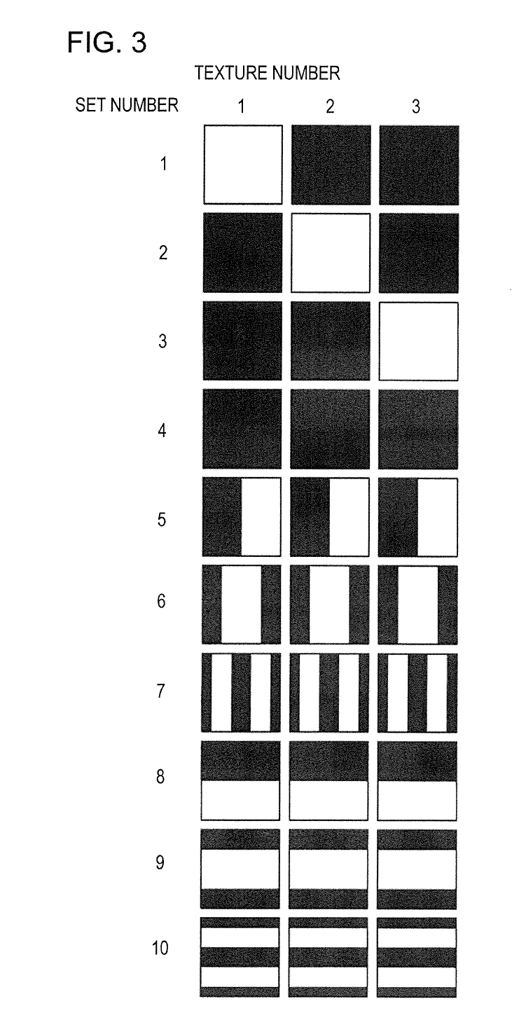

After special textures having the target set number i from a value (n+2) to a value (n+b+1) are generated, n number of the horizontally-striped special textures are generated by the next equation (4) for each color component, corresponding to {i−(n+b+2)}-th bit when the y coordinate of the texture is expressed by an reflected binary code for the target set number i (Step S185), the target set number i is increased by a value 1 (step S190), the target set number i is compared to a value (n+2b+1) (step S195), and the process returns to step S185 when the target set number i is equal to or smaller than the value (n+2b+1) to repeat the process of generating n number of special textures for the next target set number i. When the target set number i exceeds the value (n+2b+1), the generation of all special textures is completed, and then the routine ends. The (n+b+2)-th to the (n+2b+1)-th target set number i corresponds to each of the 0-th bit (the highest bit) to the (b−1)-th bit (the lowest bit) when each coordinate of the textures are expressed by binary number. Then, horizontally-striped special textures are generated by setting the grayscale of a value 1.0 (white) when the value of the bit corresponding to the target set number i is a value 1, and by setting the grayscale of a value 0.0 (black) when the value of the corresponding bit is a value 0. In the present embodiment, the coordinate of the texture is expressed by gray code. For example, when n, the number of textures, is 3, and the y coordinate has 3 bit of values 1 to 8 (b=3), and if the special texture has a value 8 representing the target set number i of the 0-th bit (the highest bit), a black grayscale value is set for the y coordinate of values 1 to 4, and a white grayscale value is set for values 5 to 8. If special texture has a value 9 representing the target set number i of the first bit, a black grayscale value is set for the y coordinate of values 1 and 2, a white grayscale value is set for values 3 to 6, and a black grayscale value is set for values 7 and 8. If the special texture has a value 10 representing the target set number i of the second bit (the lowest bit), a black grayscale value is set for the y coordinate of a value 1, a white grayscale value is set for values 2 and 3, a black grayscale value is set for values 4 and 5, a white grayscale value is set for values 6 and 7, and a black grayscale value is set for value 8. FIG. 3 shows the special textures generated when n, the number of special textures, is a value 3 and b, the number of bits, of the coordinate is a value 3.

Expression 4

When and(gray(y−1),2^{i-(n+b+2)}≠0, T_{c,i,j}(x,y):=1.0

When and(gray(y−1),2^{i-(n+b+2)}=0, T_{c,i,j}(x,y):=0.0 (4)

c:=1˜3, i:=n+b+2˜n+2b+1, j:=1˜n, x:=1˜2^{b}, y:=1˜2^{b}

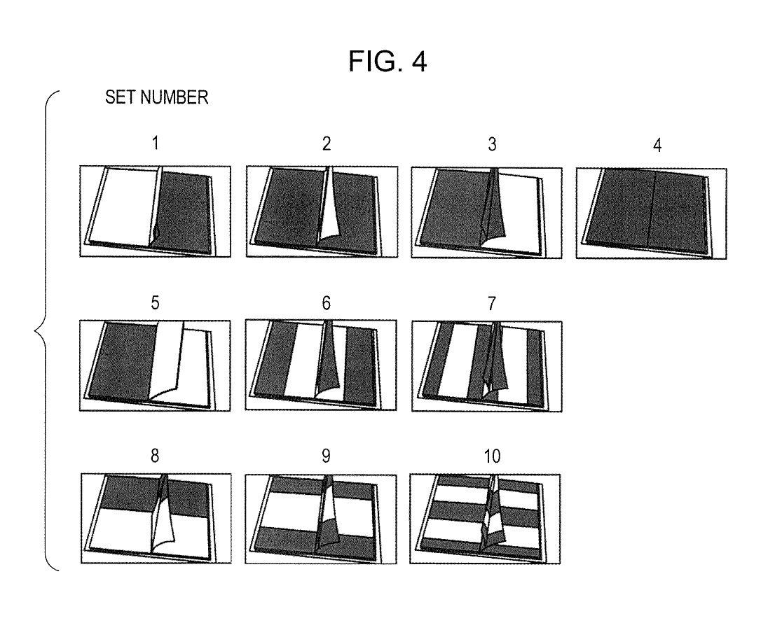

The rendering processing unit 34 performs rendering process by n number of special textures corresponding to each set to the three-dimensional model. FIG. 4 shows the appearance of the rendering process. In the present embodiment, the three-dimensional model is rendered as a dynamic image, and it is assumed that n, the number of textures, is a value 3 and b, the number of bits, is a value 3, thereby the rendering process is performed for a total of 10 sets and dynamic images for the 10 sets are generated. The dynamic images are constituted with bitmap images (rendered images) generated for each frame from frames 1 to T.

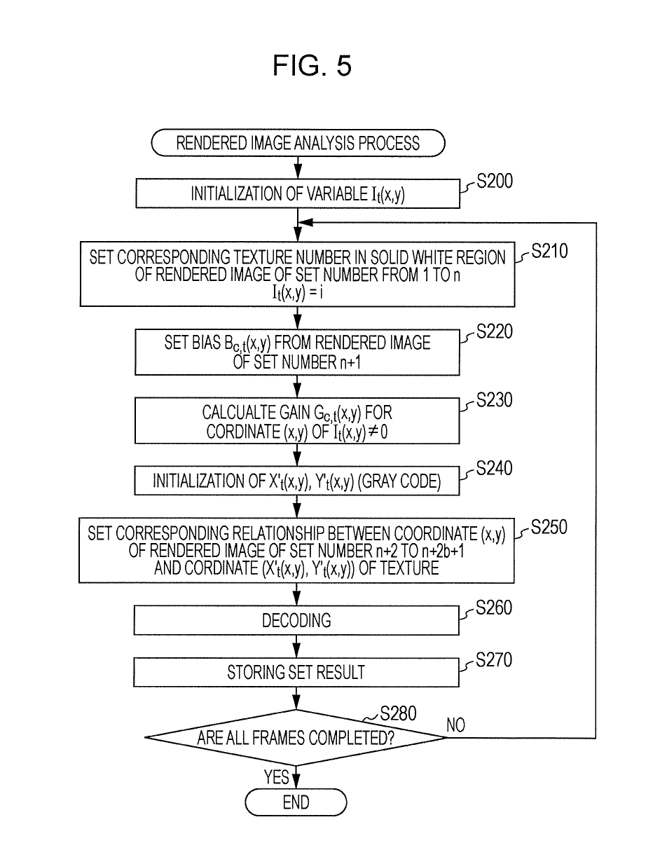

Next, a process of analyzing the rendered image generated by the rendering processing unit 34 will be described. FIG. 5 is a flowchart illustrating an example of a rendered image analysis process executed by the rendered image analysis processing unit 36.

In the rendered image analysis process, first as shown in the following equation (5), a variable Iₜ(x,y) of a coordinate (x,y) of a rendered image in each frame number t (=1 to T) is initialized to a value 0 (step S200), a solid white region (coordinate) in the rendered image of set numbers 1 to n in a target frame t is specified, and a texture number (=target set number i) corresponding to the variable Iₜ(x,y) of the solid white region is set (step S210). This process can be performed by comparing the grayscale value of the rendered image of the target set number i (the total grayscale value for each color component) to the grayscale value of the rendered image of the set number (n+1) (the total grayscale value for each color component) while sequentially replacing with the first target set number i to an n-th target set number i as shown in the following equation (6). Here, in the equation (5), ‘w’ represents the size of the rendered image in the width direction, and ‘h’ represents the size of the rendered image in the height direction. In addition, ‘A_{c,i,t}(x,y)’ in the equation (6) represents the grayscale value of the coordinate (x,y) of the rendered image for a color component c, a set number i (1 to n), and a frame number t (hereinafter, the same is applied).

$$\begin{matrix}Expression 5 \\ {I}_{t} ( x , y ) := 0 \\ t := 1 \sim T , x := 1 \sim w , y := 1 \sim h & ( 5 ) \\ When {\sum }_{c = 0}^{2} {A}_{c , n + 1 , t} ( x , y ) < {\sum }_{c = 0}^{2} {A}_{c , i , t} ( x , y ) {I}_{t} ( x , y ) := i \\ i := 1 \sim n , t := 1 \sim T , x := 1 \sim w , y := 1 \sim h & ( 6 )\end{matrix}$$

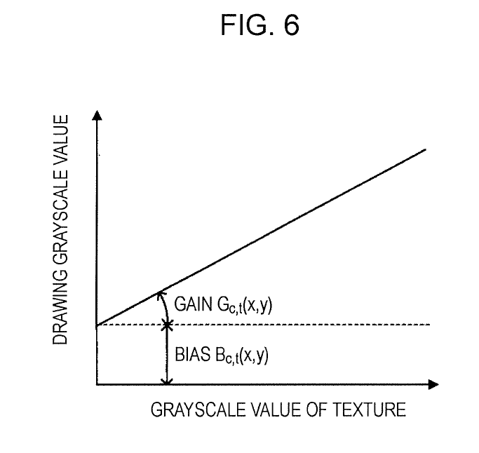

Subsequently, the grayscale value of the rendered image of the set number (n+1) is set as a bias B_{c,t}(x,y) by the following equation (7) (step S220), and a gain G_{c,t}(x,y) is calculated by the following equation (8) for the coordinate (x,y) of the rendered image of which a variable Iₜ(x,y) is not 0, that is, the white solid region (step S230). Here, ‘A_{c,It}(x,y),ₜ(x,y)’ in the equation (8) represents the grayscale value of the coordinate (x,y) of the rendered image for the frame number t and the set number i stored in the variable Iₜ(x,y), and the color component c. FIG. 6 shows the relationship between bias B_{c,t}(x,y) and the gain G_{c,t}(x,y). When rendering is performed by pasting the texture to the 3D model, as shown in the drawing, the offset amount that does not depend on the grayscale value of the original texture corresponds to the bias B_{c,t}(x,y), and the slope of the change in the grayscale value of the rendered image with respect to the change in the grayscale value of the original texture corresponds to the gain G_{c,t}(x,y).

Expression 6

B_{c,t}(x,y):=A_{c,n+1,t}(x,y) (7)

When Iₜ(x,y)≠0, G_{c,t}(x,y):=A_{c,It(x,y),t}(x,y)−B_{c,t}(x,y)

When Iₜ(x,y)=0, G_{c,t}(x,y):=0 (8)

c:=1˜3, t:=1˜T, x:=1˜w, y:=1˜h

Moreover, a coordinate (X′ₜ(x,y), Y′ₜ(x,y)) of gray code expression of a texture is initialized to a value 0 by the following equation (9) (step S240), and the corresponding relationship between the coordinate (x,y) of the rendered image from the set number (n+2) to (n+2b+1) and the coordinate (X′ₜ(x,y), Y′ₜ(x,y)) of the texture (step S250). Here, the corresponding relationship of the coordinates are drawn by the following equation (10), and particularly, while the set number i is sequentially replaced from the first to n-th, it is determined whether the value obtained by subtracting the bias B_{c,t}(x,y) from a grayscale value A_{c,i+n+1,t}(x,y) of the rendered image of the set number (i+n+1) (the total amount for each color component) is greater than the value obtained by dividing the gain G_{c,t}(x,y) of the rendered image of the set number i by a value 2 (the total amount for each color component) or not, in other words, whether the coordinate (x,y) among white and black vertically-striped patterns in the set number (i+n+1) is white or not. When the coordinate is white, the value of (i−1)-th bit corresponding to a coordinate X′ₜ(x,y) expressed by an reflected binary code is set to a value 1. While the set number i is sequentially replaced from the first to n-th, it is determined whether the value obtained by subtracting the bias B_{c,t,}(x,y) from a grayscale value A_{c,i+b+n+1,i}(x,y) of the rendered image of the set number (i+b+n+1) (the total amount for each color component) is greater than the value obtained by dividing the gain G_{c,t}(x,y) of the rendered image of the set number i by a value 2 (the total amount for each color component) or not, in other words, whether the coordinate (x,y) among white and black horizontally-striped patterns in the set number (i+b+n+1) is white or not. When the coordinate is white, the value of (i−1)-th bit corresponding to the coordinate Y′ₜ(x,y) is set to a value 1. Here, ‘or(a,b)’ in the equation (10) represents an OR operation for each bit of a and b.

Expression 7

X′ₜ(x,y):=0

Y′ₜ(x,y):=0 (9)

t:=1˜T,x:=1˜w,y:=1˜h

### When

$$\frac{{\sum }_{C = 0}^{2} {G}_{c , t} ( x , y )}{2} < {\sum }_{C = 0}^{2} {A}_{c , i + n + 1 , t} ( x , y ) - {\sum }_{C = 0}^{2} {B}_{c , t} ( x , y )$$

$${X}_{t}^{′} ( x , y ) := or ( {X}_{t}^{′} ( x , y ) , {2}^{i - 1} )$$

### When

$$\frac{{\sum }_{C = 0}^{2} {G}_{c , t} ( x , y )}{2} < {\sum }_{C = 0}^{2} {A}_{c , i + b + n + 1 , t} ( x , y ) - {\sum }_{C = 0}^{2} {B}_{c , t} ( x , y ) \\ {Y}_{t}^{′} ( x , y ) := or ( {Y}_{t}^{′} ( x , y ) , {2}^{i - 1} ) \\ i := 1 \sim b , t := 1 \sim T , x := 1 \sim w , y := 1 \sim h \qquad ( 10 )$$

If the corresponding relationship of the coordinates is set, the coordinate (X′ₜ(x,y),Y′ₜ(x,y)) of the texture of the gray code expression is decoded by using the following equation (11) and the decoded coordinate (Xₜ(x,y), Yₜ(x,y)) is calculated (step S260). The result of setting or calculating hitherto is stored in the storing unit 31 as image drawing information (step S270), and it is determined whether the process for all frames from values 1 to T is completed or not (step S280). When the process for all frames is not completed, the next frame is set to the target frame t, and the process returns to step S210 to repeat. When the process for all frames is completed, the process ends. Here, in the equation (11), ‘gray⁻¹(a)’ represents a value resulting from decoding the gray code a, ‘Xₜ(x,y)’ represents x coordinate of a texture corresponding to the coordinate (x,y) of the rendered image of the frame number t, and ‘Yₜ(x,y)’ represents y coordinate of a texture corresponding to the coordinate (x,y) of the rendered image of the frame number t. Furthermore, in the present embodiment, since the origin of the coordinate (X′ₜ(x,y), Y′ₜ(x,y)) is (1,1), a value 1 is added to the value resulting from decoding the gray code. The image drawing information includes the variable Iₜ(x,y), the bias B_{c,t}(x,y), the gain G_{c,t}(x,y), and the coordinate (Xₜ(x,y), Yₜ(x,y)).

Expression 8

Xₜ(x,y):=gray⁻¹(X′ₜ(x,y))+1

Yₜ(x,y):=gray⁻¹(Y′ₜ(x,y))+1 (11)

t:=1˜T, x:=1˜w, y:1˜h

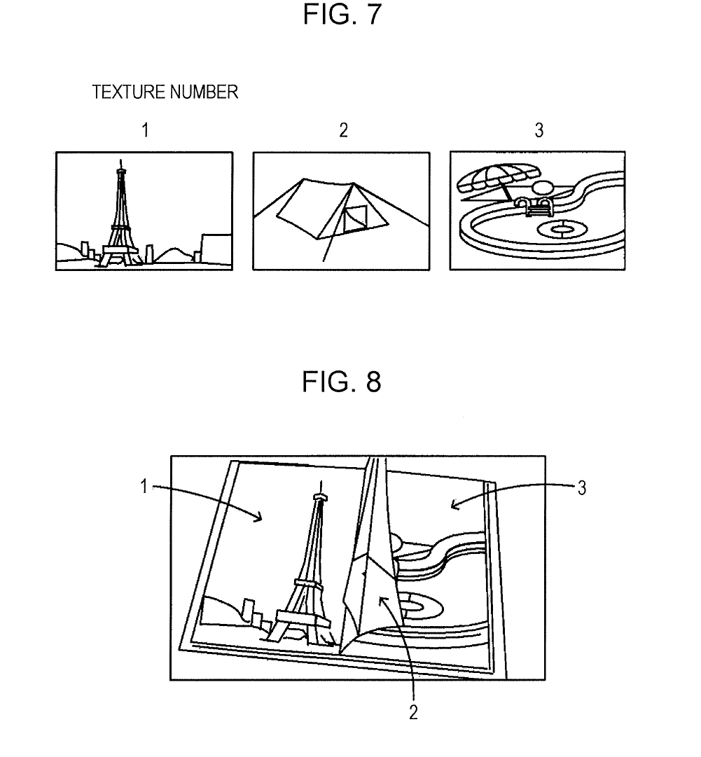

In the display processing unit 42 of the viewer 40, if the rendered image (bitmap image) generated by the rendering processing unit 34 of the computer 20 and the image drawing information generated by the rendered image analysis processing unit 36 are stored in the storing unit 41 in advance, a plurality of image data such as a picture stored in the memory card 46 is read as texture for replacement, and the texture is synthesized with the rendered image to sequentially draw an image by using the following equation (12). Thereby, a slide show for displaying the rendered image of the three-dimensional model can be reproduced while replacing the texture. Here, in the equation (12), ‘U_{c,i}(x,y) represents the grayscale value (0.0 to 1.0) of the coordinate (x,y) of a texture for replacing for the color component c and the texture number i, and ‘P_{c,t}(x,y) represents the grayscale value (0.0 to 1.0) of the coordinate (x,y) of the displayed image (rendered image) for the color component c and the frame number t. As shown in equation (12), the grayscale value P_{c,t}(x,y) of the displayed image is set to the value obtained by multiplying the grayscale value of the coordinate (Xₜ(x,y), Yₜ(x,y)) of the texture for replacement corresponding to the coordinate (x,y) of the displayed image by the gain G_{c,t}(x,y) and adding the bias B_{c,t}(x,y) thereto for a texture-arranged region where the variable Iₜ(x,y) is not a value 0, and set to the bias B_{c,t}(x,y) for a region other than a texture-arranged region where the variable Iₜ(x,y) is a value 0. FIG. 7 shows 3 textures, numbered 1 to 3, for replacement, and FIG. 8 shows the appearance of arranging the textures for replacement of FIG. 7 in the rendered image and drawing.

Expression 9

When Iₜ(x,y)≠0,

P_{c,t}(x,y):=B_{c,t}(x,y)+G_{c,t}(x,y)U_{c,It(x,y)}(Xₜ(x,y),Yₜ(x,y)

When Iₜ(x,y)=0, P_{c,t}(x,y):=B_{c,t}(x,y) (12)

c:=1˜3, t:=1˜T, x:=1˜w, y:=1˜h

According to the image display method of the embodiment described hitherto, in the computer 20, the vertically-striped pattern for the x coordinate corresponding to the value of each bit when the coordinate (x,y) is expressed by a binary number and the horizontally-striped pattern for the y coordinate are pasted to the three-dimensional model as textures to render the patterns, the corresponding relationship between the coordinate (x,y) of the rendered image and the coordinate (Xₜ(x,y), Yₜ(x,y)) of the texture are set and stored as the image drawing information by analyzing the rendered image obtained as a bitmap image through the rendering. When the viewer 40 displays the image by using the rendered image, drawing is performed in the coordinate (x,y) of the displayed image based on the grayscale value of the coordinate (Xₜ(x,y), Yₜ(x,y)) of the texture by the image drawing information stored in advance. For that reason, it is possible to reproduce the rendered image of the three-dimensional model by replacing the textures freely, and to reduce the processing burden in comparison to display by rendering the three-dimensional model in real-time. Moreover, since the grayscale value of the texture is converted and the grayscale value of the displayed image is set by using the gain G_{c,t}(x,y) and bias B_{c,t}(x,y), it is possible to include influences of, for example, refracted light, specular reflection, shadow, or the like when a three-dimensional model is rendered. Furthermore, since a vertically-striped pattern and a horizontally-striped pattern corresponding to an reflected binary code are formed as special texture for specifying the corresponding relationship of coordinates, a change always occurs by 1 bit upon moving to an adjacent coordinate, and incorrect data resulting from an error in the grayscale value of an image can be prevented from being obtained.

In the present embodiment, the vertically-striped pattern for the x coordinate and the horizontally-striped pattern for the y coordinate corresponding to the value of each bit when the coordinate (x,y) is expressed by a binary number are pasted to the three-dimensional model as the texture to render the patterns, and the image drawing information is generated by analyzing the result of the rendering, but a pattern to be used is not limited thereto, and a pattern of which density (a grayscale value) gradually changes in the x coordinate direction (horizontal direction) and a pattern of which density gradually changes in the y direction (vertical direction) may be used. In that case, one pattern of a set number (n+2) obtained by the following equation (13) may be used instead of the vertically-striped patterns of the set number from (n+2) to (n+b+1) obtained by the equation (3) described above, and one pattern of the set number (n+3) obtained by the following equation (13) may be used instead of the horizontally-striped patterns of the set number (n+b+2) to (n+2b+1) obtained by equation (4).

$$\begin{matrix}Expression 10 \\ {T}_{c , n + 2 , j} ( x , y ) := \frac{x - 1}{{2}^{b}} & ( 13 ) \\ {T}_{c , n + 3 , j} ( x , y ) := \frac{y - 1}{{2}^{b}} \\ c := 1 \sim 3 , j := 1 \sim n , x := 1 \sim {2}^{b} , y := 1 \sim {2}^{b} & ( 14 )\end{matrix}$$

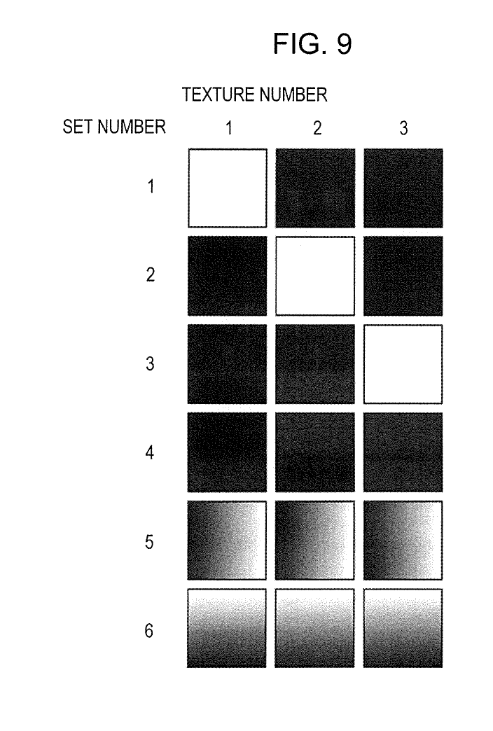

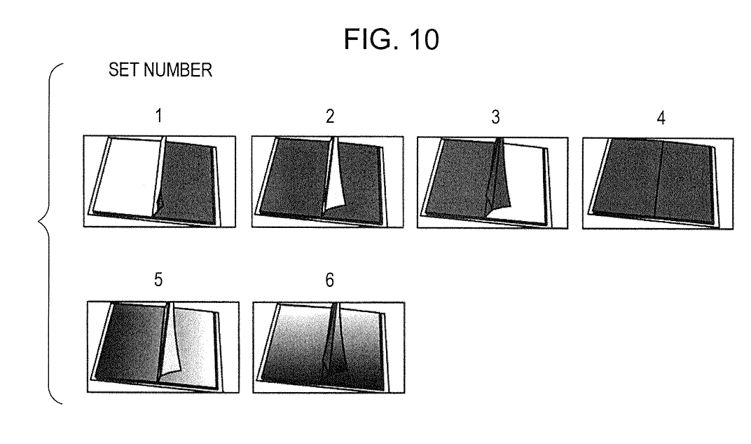

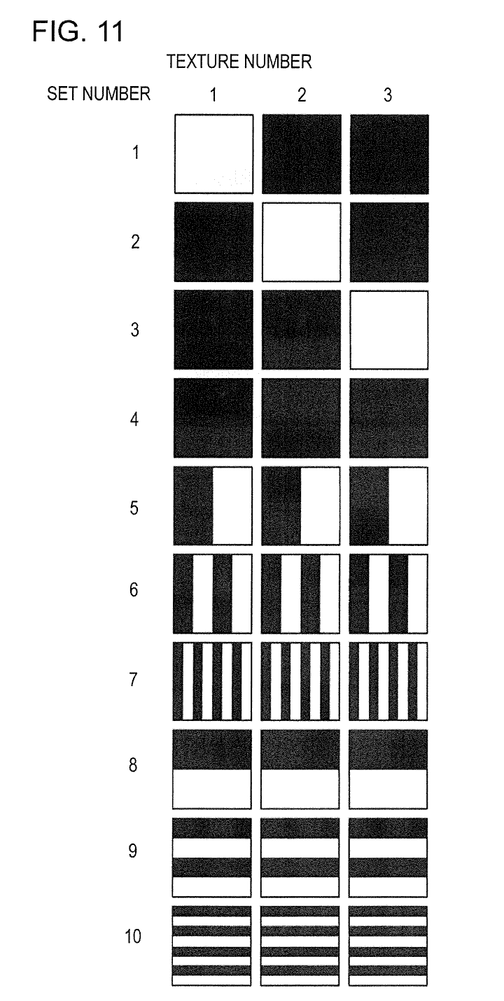

When the pattern of equation (12) and the pattern of equation (13) are used, setting of the corresponding relationship of coordinates can be obtained by the following equation (15). FIG. 9 shows an example of special textures, and FIG. 10 shows the appearance of pasting the special textures of FIG. 9 to the three-dimensional model and rendering. In that manner, it is possible to reduce the number of special textures supposed to be generated.

$$Expression 11 \\ {X}_{t} ( x , y ) := \frac{{\sum }_{C = 0}^{2} {A}_{c , n + 2 , t} ( x , y ) - {\sum }_{C = 0}^{2} {B}_{c , t} ( x , y )}{{\sum }_{C = 0}^{2} {G}_{c , t} ( x , y )} \times {2}^{b} + 1 \\ {Y}_{t} ( x , y ) := \frac{{\sum }_{C = 0}^{2} {A}_{c , n + 3 , t} ( x , y ) - {\sum }_{C = 0}^{2} {B}_{c , t} ( x , y )}{{\sum }_{C = 0}^{2} {G}_{c , t} ( x , y )} \times {2}^{b} + 1 \\ t := 1 \sim T , x := 1 \sim w , y := 1 \sim h \qquad ( 15 )$$

In the present embodiment, it is assumed that the special textures of the vertically-striped patterns having the target set number i from a value (n+2) to a value (n+b+1) correspond to the values of each bit when the coordinates are expressed by reflected binary codes, and the special textures of the horizontally-striped patterns having the target set number i from a value (n+b+2) to a value (n+2b+1) correspond to the values of each bit when the coordinates are expressed by reflected binary codes. However, the patterns may be generated assuming that the patterns correspond to the values of each bit when the coordinates are expressed by general binary numbers. FIG. 11 shows an example of the special textures in that case.

In the present embodiment, the image is reproduced by the viewer 40, but it does not matter that any apparatus such as a mobile phone, printer, or the like, which is equipped with liquid crystal display is used as apparatus reproducing an image.

The invention is not limited to the above-mentioned embodiment, and can have various embodiments as long as the embodiments belong to the technical scope of the invention.

What is claimed is:

1. A method of displaying an image, comprising:
rendering a predetermined pattern of which each coordinate is set to a different grayscale value by pasting the pattern to a three-dimensional model as a texture;
setting a corresponding relationship between a coordinate of a rendered image, which is obtained in a bitmap image form by the rendering, and a coordinate of the predetermined pattern to store the rendered image as image drawing information by analyzing the rendered image; and
arranging a desired texture in the rendered image for display based on the stored image drawing information when the desired texture is supposed to be displayed as an image.

2. The method according to claim 1, wherein the setting process is for deriving the corresponding relationship by specifying the coordinate of the predetermined pattern from a grayscale value of each coordinate of the rendered image corresponding thereto.

3. The method according to claim 1, wherein the predetermined pattern is formed such that a grayscale value according to a value of a bit corresponding to each coordinate of the pattern is set to a plurality of patterns according to the number of bits when the coordinate is expressed by a binary number.

4. The method according to claim 3, wherein the binary number is a gray code (an reflected binary code).

5. The method according to claim 1, wherein
the rendering process renders a first solid color pattern solidly painted with a minimum grayscale value by pasting the pattern to the three-dimensional model in addition to a corresponding relationship setting pattern for setting the corresponding relationship as the predetermined pattern;
the setting process stores a bias value, which is a grayscale value of the first solid color pattern in the rendered image, as the image drawing information; and
the arranging process converts the grayscale value of the desired texture into the grayscale value of the rendered image for display by offsetting the grayscale value of the desired texture based on the stored bias value.

6. The method according to claim 1, wherein
the rendering process respectively renders the first solid color pattern solidly painted with the minimum grayscale value and a second solid color pattern solidly painted with a maximum grayscale value by pasting the patterns to the three-dimensional model in addition to the corresponding relationship setting pattern for setting the corresponding relationship as the predetermined pattern;
the setting process calculates a gain, which is a difference between the grayscale value of the first solid color pattern and the grayscale value of the second solid color pattern in the rendered image, to store the gain as the image drawing information; and
the arranging process converts the grayscale value of the desired texture into the grayscale value of the rendered image based on the stored gain for display.

7. The method according to claim 6, wherein
when a plurality of desired textures are arranged in the rendered image for display in the arranging process, the rendering process renders a first set group, which is a set group provided with as many as the desired textures to be arranged, each set of which includes one second solid color pattern and the first solid color patterns the number of which is obtained by subtracting a value 1 from the number of the textures to be arranged, and each of which has a different spot where the second solid color pattern is pasted to the three-dimensional model, and a second set including the same number of the first solid color patterns as that of the desired textures to be arranged by pasting the patterns to the three-dimensional model for each of the sets; and
the setting process specifies a texture region where a texture is pasted to the three-dimensional model and calculates the gain for the specified texture region by comparing the grayscale value of each rendered image obtained by rendering the first set group for each of the sets to the grayscale value of the rendered image obtained by rendering the second set for each of the sets in the first set group.

8. The method according to claim 1, wherein an image is displayed as a dynamic image by drawing the image in a frame unit.

9. An apparatus for displaying an image, comprising:
a storing unit that stores a corresponding relationship between a coordinate of a rendered image obtained in a bitmap image form by pasting a predetermined pattern, of which each coordinate is set to a different grayscale value, to a three-dimensional model as a texture and rendering, and a coordinate of the predetermined pattern; and
a displaying unit that arranges a desired texture in the rendered image for display based on the corresponding relationship stored in the storing unit when the desired texture is supposed to be displayed as an image.
